(19) United States
(12) Patent Application Publication
(10) Pub. No.: US 2006/0114510 A1
(43) Pub. Date: Jun. 1, 2006

(54) Apparatus and method for image conversion

(75) Inventor: Sook-young Maeng, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/196,535

(22) Filed: Aug. 3, 2005

(30) Foreign Application Priority Data
Nov. 30, 2004 (KR) 10-2004-0099019

(51) Int. Cl. G06K 15/00

(52) U.S. Cl. 358/1.16

(57) ABSTRACT

An apparatus and method for image conversion are provided. The apparatus includes a file classification unit, a file conversion unit, and a control unit. The file classification unit classifies image files stored in a predetermined storage apparatus by classification criteria including at least one of the size and quality of an image, and determines a group to which each image file belongs. The file conversion unit converts image files belonging to a conversion object group selected by a user among groups according to the classification criteria, into files belonging to a conversion target group selected by the user among groups according to the classification criteria so that a storage space of the storage apparatus can be additionally secured. If a storage space securing menu is selected by the user, the control unit outputs a control command to perform a file classification operation, to the file classification unit, and if the user selects a conversion object group and a conversion target group, outputs a control command to perform a file conversion operation, to the file conversion unit.

### CROSS-REFERENCE TO RELATED PATENT APPLICATIONS

This application claims the benefit of Korean Patent Application No. 10-2004-0099019, filed on Nov. 30, 2004, in the Korean Intellectual Property Office, the disclosure of which is incorporated herein in its entirety by reference.

### BACKGROUND OF THE INVENTION

1. Field of the Invention

The present invention relates to an image conversion apparatus and method, and more particularly, to an image conversion apparatus and method that can be applied to an image pickup apparatus such as a digital camera or a digital camcorder, so that when the storage space of a detachable storage apparatus is insufficient, a storage space of the storage apparatus can be secured in order to enable additional photographing.

2. Description of the Related Art

With the increasing performance of image pickup devices, digital camera users are able to photograph images with high resolution and high picture quality.

However, an image with high resolution and high picture quality occupies much storage space, causing a shortage in the capacity of a storage apparatus mounted on a digital camera.

In the situation of insufficient storage capacity, one way to enable digital camera users to take additional photos is by deleting some of the images stored in the storage apparatus to secure additional storage space. However, the problem with securing additional storage space by deleting stored images is that it is impossible to restore the deleted images.

Another method of securing additional storage space in some digital cameras is by utilizing a storage compression function. However, the drawback to this method is that in a playback state, only one image can be recompressed at a time. This takes much time, which can be an inconvenience for the user.

### SUMMARY OF THE INVENTION

The present invention provides an image conversion apparatus and method for quickly and efficiently converting the size or quality of an image when storage space is insufficient or the size or quality of an image is desired to be changed.

The present invention also provides a computer readable recording medium having embodied thereon a computer program for executing an image conversion method for quickly and efficiently converting the size or quality of an image when storage space is insufficient or the size or quality of an image is desired to be changed.

According to an embodiment of the present invention, the image conversion apparatus includes: a file classification unit classifying image files stored in a predetermined storage apparatus by classification criteria including at least one of the size and quality of an image, and determining a group to which each image file belongs; a file conversion unit converting image files belonging to a conversion object group selected by a user among groups according to the classification criteria into files belonging to a conversion target group selected by the user among groups according to the classification criteria so that a storage space of the storage apparatus is additionally secured; and a control unit, if a storage space securing menu is selected by the user, outputting a control command to perform a file classification operation, to the file classification unit, and if the user selects a conversion object group and a conversion target group, outputting a control command to perform a file conversion operation, to the file conversion unit.

According to another embodiment of the present invention, there is provided an image conversion method including: classifying image files stored in a predetermined storage apparatus by criteria including at least one of the size and quality of an image, and determining the group to which each image file belongs; and converting image files belonging to a conversion object group selected by a user among groups according to the classification criteria, into files belonging to a conversion target group selected by the user among groups according to the classification criteria so that a storage space of the storage apparatus is additionally secured.

### BRIEF DESCRIPTION OF THE DRAWINGS

The above and other features and advantages of the present invention will become more apparent by describing in detail exemplary embodiments thereof with reference to the attached drawings in which:

FIG. 1 is a detailed block diagram of the structure of a preferred embodiment of an image conversion apparatus according to the present invention;

FIG. 2 is a detailed block diagram of the structure of a photographing unit of a photographing apparatus to which an image conversion apparatus is applied according to the present invention;

FIGS. 3A and 3B illustrates examples of OSD screens in which when the size and quality, respectively, of an image is selected as a criterion of group classification, conversion target groups that can be selected for a predetermined conversion object group selected by the user are activated;

FIG. 4 is a flowchart of the operations performed by a preferred embodiment of an image conversion method according to the present invention; and

FIG. 5 is a flowchart of the operations performed by another preferred embodiment of an image conversion method according to the present invention.

### DETAILED DESCRIPTION OF THE INVENTION

The present invention will now be described more fully with reference to the accompanying drawings, in which exemplary embodiments of the invention are shown.

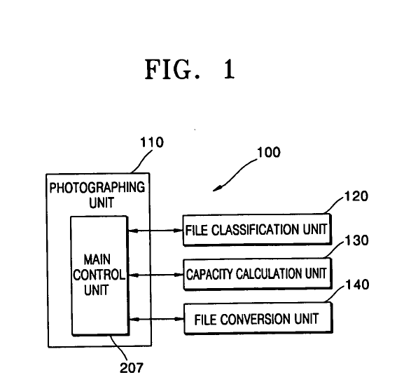

FIG. 1 is a detailed block diagram of the structure of a preferred embodiment of a photographing apparatus to which an image conversion apparatus according to the present invention is applied. Referring to FIG. 1, the photographing apparatus 100 according to the present invention includes a photographing unit 110, a file classification unit 120, a capacity calculation unit 130, and a file conversion unit 140.

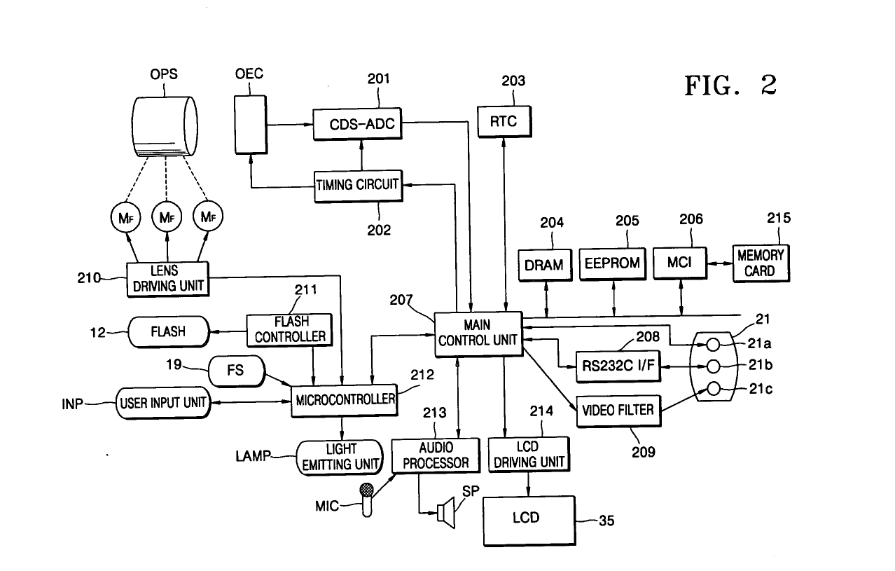

The photographing unit 110 is an element performing the function of a device capable of capturing digital images, such as a digital camera or a camcorder. FIG. 2 illustrates the structure of the photographing unit 110. An optical system (OPS) includes a lens unit and a filter unit, and optically processes light from an object. The lens unit of the OPS includes a zoom lens (ZL), a focus lens (FL), and a compensation lens (CL).

If a user pushes a wide angle-zoom button or a telephoto-zoom button included in a user input unit (INP), a signal corresponding to this is input to a microcontroller 212. Accordingly, as the microcontroller 212 controls a lens driving unit 210, a zoom motor (MZ) is driven and the zoom lens (ZL) moves. That is, if the wide angle-zoom button is pushed, the focal length of the zoom lens (ZL) is shortened and a picture angle is widened, while if the telephoto-zoom button is pushed, the focal length of the zoom lens (ZL) is lengthened and the picture angle is narrowed.

According to this characteristic, the microcontroller 212 can obtain the picture angle (θ) on the location of the zoom lens (ZL) from design data of the optical system (OPS). Here, since the location of the focus lens (FL) is adjusted with the location of the zoom lens (ZL) being set, the picture angle (θ) is hardly affected by the location of the focus lens (FL). The compensation lens (CL) performs a role compensating for the entire refractive index and is not driven separately.

Reference mark MA indicates a motor driving an aperture (not shown). Here, the rotation angle of the aperture driving motor (MA) varies according to a specified exposure mode and other modes. The specified exposure mode is a mode in which if a partial area that is desired by a user in an object area corresponds with a specified detection area displayed on the display panel 35 of the digital camera, the amount of light exposure of the digital camera for an average brightness of this specified detection area is set.

In the filter unit (not shown) of the optical system (OPS), an optical low pass filter (OLPF) removes the optical noise of a high frequency component. An infra-red cut filter (IRF) cuts off an infra-red component of incident light.

An opto-electric conversion unit (OEC) of a charge coupled device (CCD) or a complementary metal-oxide semiconductor (CMOS) converts light from the optical system (OPS) into an electric analog signal. Here, a main control unit 207 controls a timing circuit 202 to control operation of the opto-electric conversion unit (OEC) and an analog-to-digital conversion unit 201. A correlation double sampler and analog-to-digital converter (CDS-ADC) device 201 as the analog-to-digital conversion unit 201 processes an analog signal from the opto-electric conversion unit (OEC) by removing the high frequency noise and adjusting the amplitude, and converts it into a digital signal. The main control unit 207 processes the digital signal from the CDS-ADC 201 and generates a digital image signal classified by the brightness and chrominance signals.

A light emitting unit (LAMP) driven by the microcontroller 212 includes a self-timer lamp, an auto-focus lamp, and a flash wait lamp. The user input unit (INP) includes a shutter button, a mode dial, a function-selection button, a function-block button, a monitor button, a confirmation/delete button, an enter/playback button, a menu button, a wide angle-zoom button, a telephoto-zoom button, a move-up button, a move-right button, a move-down button, and a move-left button.

In a dynamic random access memory (DRAM) 204, a digital image signal from the main control unit 207 is temporarily stored. Also, in the DRAM 204, image information is temporarily stored when the image information is compressed by the main control unit 207. The DRAM 204 operates as a buffer when the image information temporarily stored is again stored in a memory card 215. In an electrically erasable programmable read only memory (EEPROM) 205, algorithms and set data required for operations of the main control unit 207 are stored.

In a memory card interface 206, the user's memory card 215 is attached and detached.

The digital image signal from the main control unit 207 is input to an LCD driving unit 214 and as a result, an image is displayed on a color LCD panel 35, or other display unit.

The digital image signal from the main control unit 207 can be transmitted in a serial communication method through a universal serial bus (USB) connection unit 21A or RS232C interface 208 and its connection unit 21B, or can be transmitted in the form of a video signal through a video filter 209 and a video output unit 21C.

An audio processor 213 outputs a voice signal from a microphone (MIC) to the main control unit 207 or a speaker (SP), and outputs an audio signal from the main control unit 207 to the speaker (SP). Meanwhile, a flash 12 is driven by the microcontroller 212 and a flash controller 211 according to a signal from a flash-light amount sensor 19.

In the embodiment depicted in FIG. 1, the file classification unit 120 classifies image files stored in a storage apparatus such as the memory card 215 according to a classification criteria including at least one of the size and quality of an image, and determines the group to which each image file belongs. The operation of the file classification unit 120 is controlled by the main control unit 207. The file classification operation is performed when a user confirms a message of insufficient storage space and selects a storage space securing command through the user input unit (INP), or when the user wants to change the size or quality of an image corresponding to stored image files if necessary and selects an image conversion command. If a storage space securing command from the user is input, the main control unit 207 commands the file classification unit 120 to perform the file classification operation for image files stored in the memory card 215.

If the classification criterion is set to the size of an image, the file classification unit 120 obtains the size of each image from the image files stored in the memory card 215. Generally, the size of an image taken by a digital camera is standardized, such as 2272×1704, 2048×1536, 1600×1200, and 1024×768 (units: pixels×pixels). Accordingly, the file classification unit 120 classifies image files stored in the memory card 215 according to the size of an image, and generates group information as shown in Table 1. The generated group information is stored in the DRAM 204, which is used as a buffer.

TABLE 1

| Size of image | Image file name |
|---|---|
| 2272 × 1704 | SV500003.JPG |
| | SV500005.JPG |
| | SV500006.JPG |
| | SV500009.JPG |
| | . |
| | . |
| | . |
| 2048 × 1536 | SV500001.JPG |
| | SV500002.JPG |
| | SV500004.JPG |
| | . |
| | . |
| | . |
| 1600 × 1200 | None |
| 1024 × 768 | SV500007.JPG |
| | SV500008.JPG |
| | SV500010.JPG |
| | . |
| | . |
| | . |
| . | . |
| . | . |
| . | . |

Also, if the classification criterion is set to the quality of an image, the file classification unit 120 obtains the quality information of each image from the image files stored in the memory card 215. Generally, the quality of an image taken by a digital camera is classified into categories such as “normal”, “fine”, “superfine”, and “non-compression”. As the compression ratio is increased, less storage space is required. At the same time, however, the quality of the image decreases.

The file classification unit 120 classifies image files stored in the memory card 215 according to the quality of the image, and generates group information as shown in Table 2. The generated group information is also stored in the DRAM 204, which is used as a buffer.

TABLE 2

| Quality of image | Image file name |
|---|---|
| Superfine | SV500006.JPG |
| | SV500009.JPG |
| | . |
| | . |
| | . |
| Fine | SV500001.JPG |
| | SV500002.JPG |
| | SV500003.JPG |
| | SV500004.JPG |
| | SV500005.JPG |
| | SV500007.JPG |
| | SV500008.JPG |
| | SV500010.JPG |
| | . |
| | . |
| | . |
| Normal | None |

SV5000011.TIF

The group information generated by the file classification unit 120 is output to the user through the color LCD panel 35. At this time, on the color LCD panel 35, images of image files belonging to each group are output in the form of thumbnails, or titles of image files belonging to each group are output. Through the user input unit (INP), the user selects a conversion object group whose files the user wants to convert in the output group information.

At this time, the main control unit 207 generates and outputs an OSD screen on which a group requiring a smaller storage space than the conversion object group can be selected by the user. For example, if the image files are classified according to the sizes in Table 1 and a user selects the group of files that are 2048×1536, the main control unit 207 would display the group of image files with a size of 1600×1200 and the group of image files with a size of 1024×768 as selectable conversion target groups.

In the alternative, if the image files are classified according to the quality of the image as shown in Table 2 and a user selects the group of image files with “fine” quality, the main control unit 207 would display the group of image files with “normal” quality as a selectable conversion target group. Thus, the group activated by the main control unit 207 as a selectable conversion target group is output to the user in the form of an OSD screen through the color LCD panel 35.

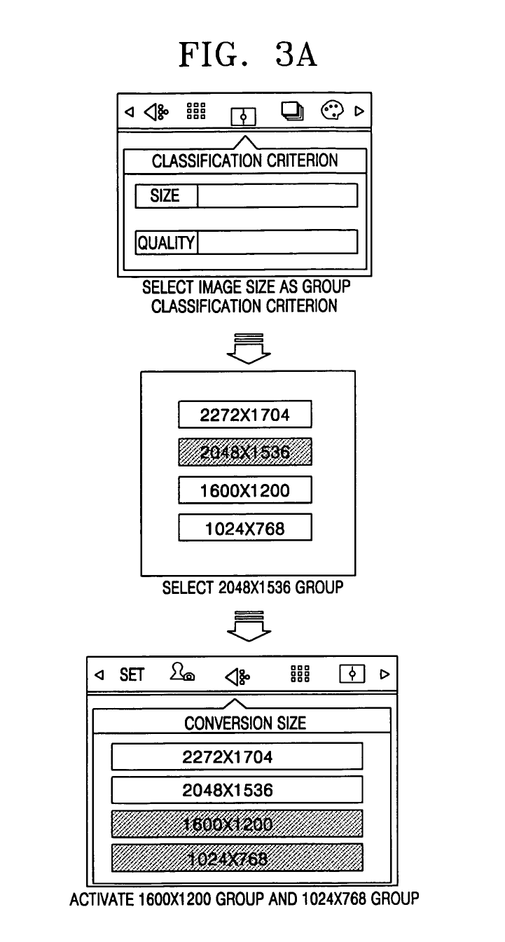

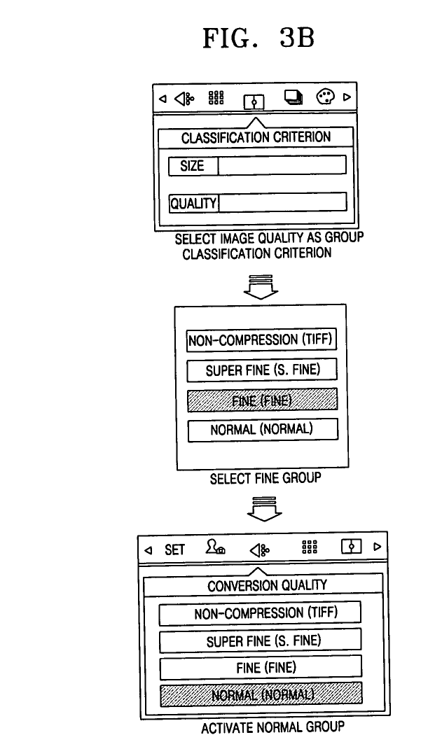

FIGS. 3A and 3B illustrate examples of OSD screens in which when the size and quality, respectively, of an image is selected as a criterion of group classification, conversion target groups that can be selected for a predetermined conversion object group selected by the user are activated.

The capacity calculation unit 130 calculates the size of the storage space that can be secured in the memory card 215 by performing a file conversion. The calculation is based on the space occupied by the image files selected by the user before conversion and the space that would be occupied by the files after conversion to the conversion target group. The calculated size of the storage space is output to the user through the color LCD panel 35. Because of this feature, a user can know in advance the capacity of the storage space that can be secured through the file conversion. Accordingly, when a group of image files with a 2048×1 536 size and a group of image files with a 1600×1 200 size are selected as a conversion object group and a conversion target group, respectively, if the capacity of the storage space that can be secured is smaller than the capacity that is required by the user, the user can change the conversion target group to the group of image files with the smaller 1024×768 size in order to secure a more storage space.

The file conversion unit 140 converts image files belonging to the conversion object group into files belonging to the conversion target group. For example, if the user selects the group of image files with a 2048×1 536 size and the group of image files with a 1024×768 size as a conversion object group and a conversion target group, respectively, the file conversion unit 140 converts image files with a 2048×1536 size into image files with a 1024×768 size without changing the picture quality, and then, replaces the image files with a 2048×1 536 size with the image files with a 1024×768 size in the memory card 215. During conversion, the file conversion unit 140 temporarily stores the converted image files with a 1024×768 size in the DRAM 204, using it as a buffer. When the conversion is finished, the file conversion unit 140 places the converted files in the memory card 215. If the user selects a group of image files with “superfine” quality and a group of image files with “fine” quality as a conversion object group and a conversion target group, respectively, the file conversion unit 140 converts the image files with a “superfine” quality stored in the memory card 215, into image files with a “fine” quality without changing the size of an image, and then replaces the image files with a “superfine” quality with the image files with a “fine” quality in the memory card 215.

The file conversion unit 140 can be designed to exclude certain files that are designated as preservation object image files, or preserved files. Preserved files are not converted even if they belong to the conversion object group. In this embodiment, the file conversion unit 140 recognizes an image for which a “lock” or “protection” function is set among images stored in the memory card 215 as a preservation object image file.

The file conversion unit 140 can also be designed to allow a user to select files to be preserved when the user performs the file conversion. In this embodiment, the file conversion unit 140 converts all image files belonging to the conversion object group into files belonging to the conversion target group, except the files selected to be preserved by the user.

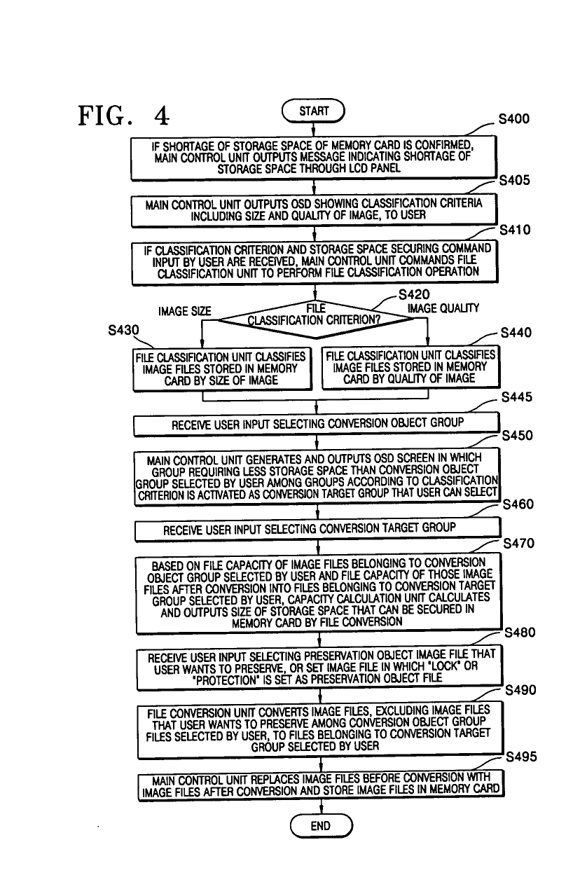

FIG. 4 is a flowchart of the operations performed by a preferred embodiment of an image conversion method in a photographing apparatus to which the image conversion apparatus according to the present invention is applied.

Referring to operation S400 in FIG. 4, if it is confirmed that the storage space of the memory card 215 is insufficient, the main control unit 207 outputs a message through the LCD panel 35 to the user indicating that the storage space is insufficient. Next, the main control unit 207 outputs an OSD showing classification criteria including the size and quality of an image, to the user through the color LCD panel 35 in operation S405. Next, if inputs of a desired classification criterion and a storage space securing command from the user are received through the user input unit (INP), the main control unit 207 commands the file classification unit 120 to perform a file classification operation in operation S410. The file classification unit 120 confirms the classification criterion selected by the user in operation S420.

If the user selects the size of an image as the classification criterion, the file classification unit 120 classifies image files stored in the memory card 215 according to the size of an image in operation 430. Conversely, if the user selects the quality of an image as the classification criterion, the file classification unit 120 classifies image files stored in the memory card 215 according to the quality of an image in operation S440. When the classification by the file classification unit 120 is complete, the user selects a conversion object group. The selection is received by the main control unit 207 in operation S445. Next, the main control unit 207 generates and outputs an OSD screen in which groups requiring less storage space than the conversion object group selected by the user among the groups according to the classification criterion are activated as conversion target groups that can be selected by the user in operation S450. In a preferred embodiment, only those groups that require less space than the conversion object group would be displayed as conversion target groups to ensure that the user is successful in securing additional space in memory card 215.

Next, the main control unit 207 receives an input from the user selecting a conversion target group in operation S460. The capacity calculation unit 130 calculates the size of the storage space that can be secured in the memory card 215 by the conversion, based on the file capacity of image files belonging to the conversion object group selected by the user, and the file capacity of the files belonging to the conversion object group selected by the user after converting into files belonging to conversion target groups in operation S470. The calculated size of the storage space is output to the user through the color LCD panel 35. Because of operation S470, a user can learn how much space will be freed by a file conversion before the conversion actually takes place. If the storage space that will be freed is less than desired, the user can select another conversion target group.

Next, the main control unit 207 receives input from the user selecting a desired preservation object image file among the image files belonging to the conversion target group, or sets an image file for which a “lock” or “protection” function is set, as a preservation object image file in operation S480. At this time, the operations S470 and S480 can be designed to be performed selectively. The file conversion unit 140 converts the image files of the conversion object group selected by the user, excluding the preservation object image files, into files belonging to the conversion target group selected by the user in order to additionally secure the storage space of the memory card 215 in operation S490. Next, the main control unit 207 replaces the image files before the conversion with the converted image files and stores the image files in the memory card 215 in operation S495.

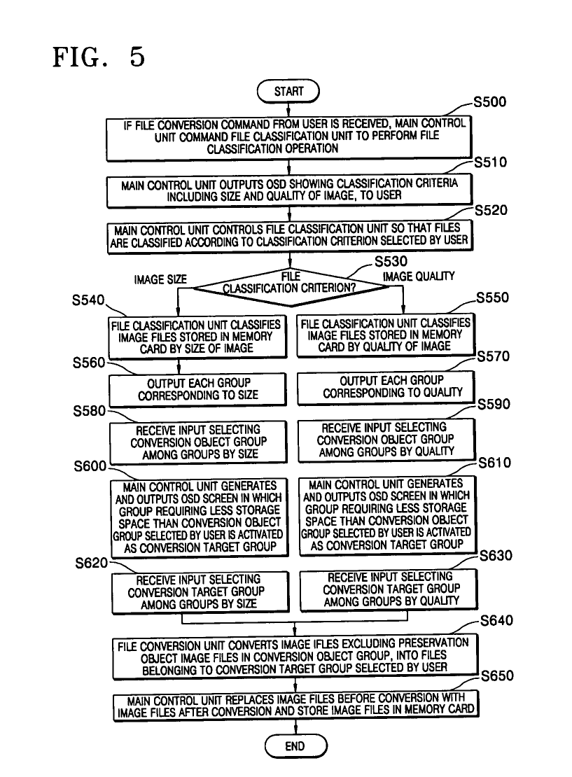

FIG. 5 is a flowchart of the operations performed by another preferred embodiment of an image conversion method according to the present invention.

Referring to FIG. 5, if a file conversion command from a user is received through the user input unit (INP), the main control unit 207 commands the file classification unit 120 to perform a file classification operation in operation S500. In operation S510, the main control unit 207 outputs an OSD showing classification criteria including the size and quality of an image to the user through the color LCD panel 35.

Next, the user selects a classification criterion, which is sent to the main control unit 207. The main control unit 207 controls the file classification unit 120 so that the image files are classified by the classification criterion selected by the user in operation S520. If the user selected the size of an image as the classification criterion in operation S530, the file classification unit 120 classifies the image files according to size in operation 540. Conversely, if the user selected the quality of an image as the classification criterion in operation S530, the file classification unit 120 classifies the image files according to quality in operation S550. When classification by the file classification unit 120 is complete, the main control unit 207 outputs the classified groups to the user through the color LCD panel 35 in operations S560 and S570. At this time, selectively, the groups classified by the classification criterion selected by the user and images corresponding to the image files belonging to each group can be output in the form of thumbnails to the user through the color LCD panel 35.

When classification by the file classification unit 120 is complete, the user is allowed to select one of the classified groups displayed in operations S560 and S570 as a conversion object group. The selection is sent to the main control unit 207 in operations S580 and S590. Next, the main control unit 207 generates and outputs an OSD screen in which groups requiring less storage space than the conversion object group are activated as conversion target groups that can be selected by the user in operations S600 and S610. In a preferred embodiment, only those groups that require less space than the conversion object group would be displayed as conversion target groups to ensure that the user is successful in securing additional space in memory card 215.

In operations S620 and S630, the main control unit 207 receives the user's selection for the conversion target group. Next, the size of the storage space that can be secured is calculated by the capacity calculation unit 130 and is displayed to the user through the color LCD panel 35. Next, the file conversion unit 140 converts the size or quality of each image so that image files originally belonging to the conversion object group, excluding preservation object files, belong to the conversion target group in operation S640. Next, the main control unit 207 replaces the image files before the conversion with the converted image files and stores the image files in the memory card 215 in operation S650.

The previous embodiments describe ways in which an image conversion apparatus can be applied to a digital camera. The image conversion apparatus and method according to the present invention can also be applied to other apparatuses, such as a motion picture photographing apparatuses, or more specifically digital camcorders. Furthermore, if the apparatus and method are applied to an information processing apparatus such as a personal computer, a bundle conversion of image files stored in a storage apparatus such as a hard disc and a memory card is enabled. When the image conversion apparatus according to the present invention is applied to an apparatus having a microprocessor, the microprocessor of the apparatus to which the image conversion apparatus is mounted performs the function and role of the main control unit of the image conversion apparatus according to the present invention.

The present invention can also be embodied as computer readable codes on a computer readable recording medium. The computer readable recording medium is any data storage device that can store data which can be thereafter read by a computer system. Examples of the computer readable recording mediums include read-only memory (ROM), random-access memory (RAM), CD-ROMs, magnetic tapes, floppy disks, optical data storage devices, and carrier waves (such as data transmission through the Internet). Computer readable recording mediums can also be distributed over a network coupled computer systems so that the computer readable code is stored and executed in a distributed fashion.

According to the image conversion apparatus and method of the present invention, when the storage space of a storage apparatus mounted on a photographing apparatus is insufficient, the files stored in the storage apparatus are not deleted but the storage space can be secured to take additional photos. Also, the files stored in the storage apparatus are classified by size or quality and a group of files are converted together so that the size or quality of each file takes a smaller storage space. By doing so, additional storage space can be quickly and efficiently secured in the storage apparatus. Furthermore, when the user wants to change the size or quality of an image, the image file can be quickly and efficiently converted.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A digital imaging device comprising:
a file classification unit that classifies a plurality of image files in a storage medium into a plurality of groups based on classification criteria including at least one of a size and quality of an image; and
a file conversion unit that converts at least one image file from a first group of the plurality of groups to a second group of the plurality of groups, whereby additional storage space is secured on the storage medium.

2. The digital imaging device of claim 1 further comprising:
a user interface that gives a user an option to increase the amount of storage space available on the storage medium in response to the user selecting the option.

3. The digital imaging device of claim 1 further comprising:
a control unit that, upon receiving a signal that additional storage space is needed, sends a command to the file conversion unit to convert at least one file from the first group to the second group, whereby additional storage space is secured on the storage medium.

4. The digital imaging device of claim 3, wherein the control unit displays at least two groups requiring less storage space than the first group, whereby one of said at least two groups can be selected by a user as the second group.

5. The digital imaging device of claim 1 further comprising:
a capacity calculation unit that calculates the amount of space that can be freed in the storage medium by file conversion based on the space occupied by image files belonging to the first group and the space that would be occupied if said image files belonged to the second group.

6. The digital imaging device of claim 2, wherein the user interface allows the user to designate at least one file as preserved and the file conversion unit does not convert the image files designated as preserved.

7. The digital imaging device of claim 1, wherein the device is selected from the group consisting of a digital camera, a part of a computer and a part of a camera phone.

8. A method for securing additional storage space on a digital imaging device comprising:
obtaining a plurality of digital images;
storing the plurality of digital images on a storage medium of the device as a plurality of image files;
selecting image file classification criteria including at least one of a size and quality of an image;
classifying the plurality of image files in the storage medium into a plurality of groups according to the selected classification criteria; and
converting said plurality of image files from a first group of the plurality of groups to a second group of the plurality of groups, whereby additional storage space is secured on the storage medium.

9. The method of claim 8, wherein the classification criteria is selected by a user.

10. The method of claim 8 further comprising:
calculating the amount of space that can be freed in the storage medium by file conversion based on the space occupied by image files belonging to the first group and the space that would be occupied if said image files belonged to the second group.

11. The method of claim 8, further comprising:
allowing a user to designate at least one file as preserved, whereby the files designated as preserved are not converted.

12. The method of claim 8 further comprising:
displaying at least two groups requiring less storage space than the first group, whereby one of said at least two groups can be selected by a user as the second group.

13. A computer readable recording medium having embodied thereon a computer program for executing the storage space securing method of claim 8.

14. The method of claim 8, wherein the method is executed on one of the group consisting of a digital camera, a computer and a camera phone.

15. A digital imaging device comprising:
an optical system including a lens, a filter and an aperture for receiving a light from a subject;
an opto-electric conversion unit for converting the light to image data;
a storage medium for storing the image data in an image file;
a display for displaying the image data;
a control unit including a microcontroller, the control unit being connected with the opto-electric conversion unit, the storage medium and the display screen, the control unit being operative in a photographing mode to process and store the image data and, in a stored-image display mode, to display an image relative to the image data;
a file classification unit that classifies a plurality of image files in the storage medium into a plurality of groups based on classification criteria including at least one of a size and quality of an image; and
a file conversion unit that converts image files from a first group of the plurality of groups to a second group of the plurality of groups, whereby additional storage space is secured on the storage medium.

16. The digital imaging device of claim 15, wherein the control unit, upon receiving a signal that additional storage space is needed, sends a command to the file conversion unit to convert at least one file from the first group to the second group, whereby additional storage space is secured on the storage medium.

17. The digital imaging device of claim 15, wherein the control unit displays at least two groups requiring less storage space than the first group, whereby one of said at least two groups can be selected by a user as the second group.

18. The digital imaging device of claim 15, further comprising:
a capacity calculation unit that calculates the amount of space that can be freed in the storage medium by file conversion based on the space occupied by image files belonging to the first group and the space that would be occupied if said image files belonged to the second group.

19. The apparatus of claim 15 further comprising:
a user interface that allows a user to designate at least one file as preserved and the file conversion unit does not convert the image files designated as preserved.

20. The digital imaging device of claim 15 further comprising:
a user interface that gives a user an option to increase the amount of storage space available on the storage medium in response to the user selecting the option.
